(19) United States
(12) Patent Application Publication
(10) Pub. No.: US 2023/0334631 A1
(43) Pub. Date: Oct. 19, 2023

(54) Glare Reduction in Images

(71) Applicant: Hewlett-Packard Development Company, L.P., Spring, TX (US)

(72) Inventors: Robert Gregory Campbell, Palo Alto, TX (US); Christopher Steven, Spring, TX (US); Isaac Lagnado, Spring, TX (US)

(73) Assignee: Hewlett-Packard Development Company, L.P., Spring, TX (US)

(21) Appl. No.: 18/043,904

(22) PCT Filed: Sep. 15, 2020
(86) PCT No.: PCT/US2020/050907

§ 371 Date: Mar. 2, 2023

(51) Int. Cl. G06T 5/50; H04N 23/72; H04N 23/76; H04N 23/74; G06T 5/00

(52) U.S. Cl. CPC G06T 5/008; G06T 5/50; H04N 23/72; H04N 23/74; H04N 23/76; G06T 2207/10016; G06T 2207/20081; G06T 2207/20084

(57) ABSTRACT

An example non-transitory machine-readable medium includes instructions to capture a first image of a scene that includes light emitted by a display device, change a brightness of the display device, capture a second image of the scene while the brightness of the display device is changed, train a machine-learning model with the first image and the second image to provide a filter to reduce glare, and apply the machine-learning model to a third image captured of the scene to reduce glare in the third image, which is different from the first and second images.

### BACKGROUND

Video capture typically involves the capture of time-sequenced image frames. Video capture may be used in videoconferencing to provide visual communication among various users at different locations through a computer network. Videoconferencing may be facilitated by real-time video capture performed by computing devices at different locations. Video capture may also be used in other applications, such as the recording of video for playback later.

### BRIEF DESCRIPTION OF THE FIGURES

FIG. 1 is a block diagram of an example non-transitory machine-readable medium that includes glare-reduction instructions that control a light source to train a machine-learning model to remove or reduce glare in captured images.

FIG. 2 is a flowchart of an example method of controlling a light source to train a machine-learning model to remove or reduce glare in captured images.

FIG. 3 is a flowchart of an example method of controlling a light source to train a machine-learning model to remove or reduce glare in captured images, including training the machine-learning model in response to an event.

FIG. 4 is a block diagram of an example device that controls a light source to train a machine-learning model to remove or reduce glare in captured images.

FIG. 5 is a block diagram of an example device that controls a light source to train a machine-learning model to remove or reduce glare in captured images, where such glare is caused by a plurality of light sources.

### DETAILED DESCRIPTION

Captured images, such as frames of digital video, may include glare that may be caused by a subject’s eyeglasses or other reflective surface, such as an identification badge, transparent face shield, visor, metallic badge, fashion accessory, or similar. During a videoconference, such glare may be created by light emitted by a participant’s display device and captured by the participant’s camera. Glare in videoconferencing moves and changes, as the participant moves their head in three dimensions (e.g., x-y-z translation, yaw, pitch, and roll) and as the content on their display device changes. This may be distracting to other users in the videoconference and may reduce the verisimilitude of a videoconfererence by subtly reminding participants that they are communicating via cameras and display devices. In addition, glare may reduce privacy and confidentiality, as sensitive information (e.g., a document page) may be visible in a reflection. Even if content in a glare reflection is unintelligible or unreadable, characteristics discernable in the glare, such as color, shape, and motion, may still reveal sensitive information.

Glare caused by light with transitive characteristics that is reflected from eyeglasses or other movable reflective surface may confound simple filters. Moreover, in videoconferencing, such glare often cannot be reduced by simply moving the glare-causing light source, as the position of the light source is often instrumental to proper functioning of the videoconference.

The brightness of a display device may be modulated to vary the glare in captured images. Such images may be used to train a machine-learning model to provide a filter to remove glare. For example, a display backlight may be turned off (“blanked”) for a short time to prevent display glare from occurring in a video frame, after which the backlight is returned to its normal brightness. In other examples, the brightness of the backlight may be increased or maximized. As such, frames with different levels of glare are captured. The machine-learning model computes a filter to remove glare based on the information provided by such captured frames. That is, images of the same scene, which are proximate in time and which have different brightness levels and resulting glare, provide a characterization of the glare to train the machine-learning model. The trained model may be applied to newly captured frames to reduce or eliminate glare. In addition, other brightness levels different from “blanking” may also be used to quantify and train a model for the glare removal. For example, by using multiple brightness levels, complete blanking of brightness may be avoided, and in so doing the effect of blanking (which may reduce overall brightness in a way that is perceptible to the user) may be reduced.

Since glare may move and change in character over the course of a videoconference, reduced-glare target frames may be captured at intervals and the machine-learning model may be continually trained over the course of the videoconference. A rate of blanking may be reduced over time, such that an initial period of camera activity may have higher occurrences of blanking in order to train the model, and a latter period of camera activity may have reduced occurrences of blanking.

These same techniques may be used in other applications of video capture, such as the capture of video for later playback.

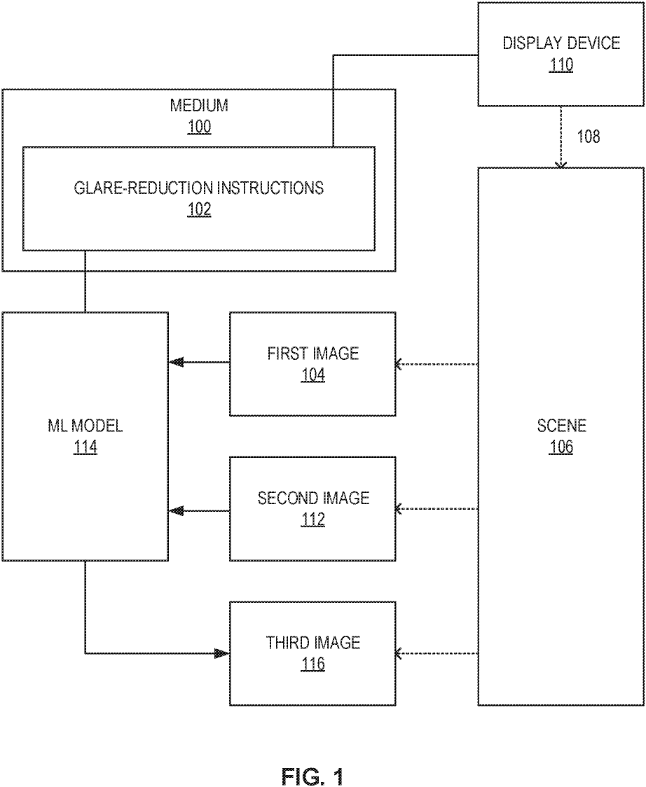

FIG. 1 shows an example non-transitory machine-readable medium 100 that includes glare-reduction instructions 102 that remove or reduce unwanted glare in a captured image. The glare-reduction instructions may implement a dynamic filter, as discussed below, such that glare may be removed or reduced in real time or near real time, such as during a live videoconference or during another type of video capture. As such, viewer distraction or a viewer-perceived reduction in quality that may be caused by glare, such as the glare that is often caused by eyeglasses, may be reduced or eliminated.

The non-transitory machine-readable medium 100 may include an electronic, magnetic, optical, or other physical storage device that encodes the instructions. The medium may include, for example, random access memory (RAM), read-only memory (ROM), electrically-erasable programmable read-only memory (EEPROM), flash memory, a storage drive, an optical device, or similar.

The medium 100 may cooperate with a processor that may include a central processing unit (CPU), a microcontroller, a microprocessor, a processing core, a field-programmable gate array (FPGA), an application-specific integrated circuit (ASIC), or a similar device capable of executing the instructions.

The glare-reduction instructions 102 may be directly executed, such as a binary file, and/or may include interpretable code, bytecode, source code, or similar instructions that may undergo additional processing to be executed.

The instructions 102 capture a first image 104 of a scene 106 that includes light 108 emitted by a display device 110. The first image 104 may be a frame of a video. Image capture may be performed using camera, such as a webcam used during a videoconference or other video capture process. The first image is expected to include glare.

The display device 110 may be a monitor that is used during the videoconference or video capture. The display device 110 may include a liquid-crystal display (LCD) device, light-emitting diode (LED) display device, or similar display device. The display device 110 may have a controllable brightness, such as a controllable backlight.

The camera and display device 110 may be facing the same user who is part of the scene and who may be a participant in a videoconference or may otherwise be capturing video of themselves. Light emitted 108 by the display device 110 may cause glare in captured images, such as by reflecting off the user’s eyeglasses. In other examples, another light source causes glare, such as a lamp (e.g., a ring light). As such, the first image 104 is expected to include glare.

The instructions 102 change a brightness of the display device 110, or other glare-causing light source, and then capture a second image 112 of the scene 106 while the brightness is reduced. The change in display brightness may be achieved by momentarily turning off a backlight of the display device 110, such as for one frame of video capture. Turning off the backlight may be referred to as blanking the display. The display device 110 brightness may be reduced or blanked for any suitable duration, such as may be quantified by a number of frames, such as one, two, or three frames. The shorter the duration of blanking, the less likely the blanking will be noticed by the user, who is normally expected to be looking at the display device 110 during a videoconference. As the display device 110 is momentarily turned off during capture of the second image 112, the second image 112 does not include significant glare caused by the display device 110. The same can be said for another controllable light source, such as a lamp that the user may use to illuminate their face during a videoconference.

In other examples, the brightness of the display device 110 is momentarily increased or maximized instead of or in addition to being reduced or blanked. Momentarily increasing brightness may momentarily increase glare, and this information along with an image with normal glare is sufficient to identify and characterize the glare under normal conditions that is desired to be removed. While examples discussed herein consider momentarily reducing the brightness of the display device to obtain a reduced-glare image, it should be understood that momentarily increasing the brightness to obtain an increased-glare image may additionally or alternatively be done to achieve a comparable result.

The first image 104 is a true-brightness image of the scene 106 that forms, or is like images that form, the videoconference or video, while the second image 112 is a reduced-brightness image that is used for glare correction. The terms “first,” “second,” “third,” etc. do not limit the time order of image capture. For example, the first image 104 may be captured before or after the second image 112. Accuracy of glare correction increases as the first and second images 104, 112 are closer together in time.

The instructions 102 train a machine-learning model (ML model) 114 with the first and second images 104, 112. As the first and second images 104, 112 are proximate in time (e.g., within 1-3 video frames), they show approximately the same physical representation of the scene 106. That is, differences in the first and second images 104, 112 caused by motion in the scene 106 are likely small. This is particularly true in a videoconference where subjects in the scene 106 normally do not move very quickly. Thus, the first and second images 104, 112 may be considered to represent two versions of the same scene: 1) a true-brightness version with glare caused by the display device 110 (first image 104) and, 2) a reduced-brightness version without glare caused by the display device 110 (second image 112). The first image 104 has a normal overall brightness level and may contain glare. The second image 112 has a reduced overall brightness level with reduced or eliminated glare. The machine-learning model 114 is thus provided with sufficient information to characterize glare caused by the display device 110. As such, the machine-learning model 114 may be trained to provide a filter to reduce such glare.

The machine-learning model 114 may include a convolutional neural network (CNN), such as a dilated causal CNN. A dilated causal CNN may be configured as revisionist, in which data may be fed back to aid in reevaluation of past data samples.

In various examples, the second image 112 is provided as a brightness target for the machine-learning model 114. The model 114 is then trained to generate a filter to bring the first image 104 close to the brightness target. Conceptually speaking, the second image 112 may be considered to be a two-dimensional map of target brightness levels and the machine-learning model 114 may be trained to filter the first image 104 to conform to the map as closely as possible.

Brightness may be color-independent intensity, as the content displayed on the display device 110, and therefore the resulting glare, may contain various colors. The machine-learning model 114 may be trained to filter out glare irrespective of its color composition.

The instructions 102 may capture reduced-brightness (second) images 112 and train the machine-learning model 114 at various intervals, so as to continually train the machine-learning model 114 during a videoconference or video capture. For example, during a videoconference, the capture of a reduced-brightness image 112 and the training of the machine-learning model 114 may be performed every 30, 60, or 90 frames. Capture of true-brightness (first) images 104 is incidental as these are the images that make up the captured video. Reduced-brightness images 112 may be omitted from the captured video and discarded after use in training the model 114. A temporally proximate true-brightness image 104 may be duplicated to replace an omitted reduced-brightness image 112.

The instructions 102 apply the machine-learning model 114 to a third image 116 captured of the scene 106, so as to reduce glare in the third image 116. The third image 116 is a true-brightness image that is different from the first and second images 104, 112. For example, the machine-learning model 114 may be applied to a sequence of video frames (third images 116) between intervals of capture and training using a reduced-brightness image 112, so as to filter the captured video to remove or reduce glare. All or the majority of the video may be formed of third images 116 that are filtered using the trained machine-learning model 114. First images 104 may be filtered as well for inclusion in the video. Second images 112 may be discarded.

Training of the machine-learning model 114 may take time and need not be completed immediately after capture of the first and second images 104, 112. The third image 116 described above may occur several frames, seconds, minutes after capture of the first and second images 104, 112. Training may be initiated soon after capture of the first and second images 104, 112 and may be allowed to occur according to other constraints, such as available processing and memory resources not used for video capture. In the meantime, an earlier version of the trained machine-learning model 114 may be used. Accordingly, a copy of the machine-learning model 114 may be trained while the original is used to filter glare. The copy becomes the new original when training is completed, and a new copy may be made at the next occurrence of training.

The instructions 102 may control a frequency of the intervals of capture of reduced-brightness (second) images 112 and training of the machine-learning model 114. Frequency may be controlled based on an error function of the model 114 or based on content displayed by the display device 110.

The instructions 102 may apply an error (or loss) function when applying the machine-learning model 114. For example, backpropagation may be performed with a glare-corrected third image 116. The error function may be used to control a frequency of the intervals of capture of reduced-brightness (second) images 112. A larger error may increase the frequency. For example, during a videoconference, an abrupt change in user posture or facing may increase error. In response, the instructions 102 may increase the frequency of reduced-brightness image capture 112 and model training so as to dynamically react to the change in glare that increased the error. Conversely, frequency of reduced-brightness image 112 capture and model training may be reduced as error decreases due to the increased accuracy of the model 114 as it is trained over the course of the videoconference.

The instructions 102 may trigger the reduction of the brightness of the display device 110 and the capture of reduced-brightness images 112 based on displayed content of the videoconference. That is, content shown on the display device 110 may change over time and may be used to trigger an interval of training of the machine-learning model 114. For example, when content changes significantly (e.g., switching from videoconference participant’s face to a shared document), a reduced-brightness image 112 may be captured and the machine-learning model 114 may be trained to account for a possible change in glare that corresponds to the change in content.

As discussed above, the glare-reduction instructions 102 provide for real-time or near real-time correction for glare in captured video, such as during a videoconference. Glare correction becomes progressively more accurate, as the machine-learning model 114 is trained over the course of the capture. Further, the glare correction may be dynamically responsive to changes in the video, such as may occur due to movement of the subject and presentation of content (e.g., screen sharing).

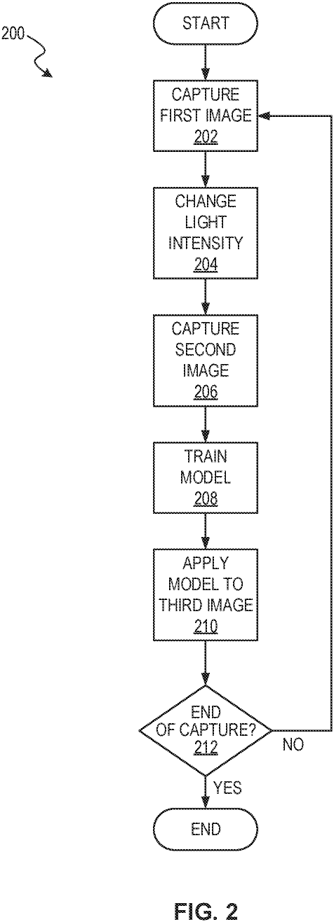

FIG. 2 shows an example method 200 to reduce glare in captured images, such as frames of video. The method 200 may be implemented with instructions that may be stored in non-transitory machine-readable media and executed by a processor. Detail concerning elements of the method 200 described elsewhere herein will not be repeated at length below; the relevant description provided elsewhere herein may be referenced for elements identified by like terminology or reference numerals.

At block 202, a first image of a scene is captured. The first image includes light emitted by a light source, such as a display device, lamp, or other controllable light source. A display device may be used facilitate a videoconference. A lamp may be used by a user to illuminate their face or other subject during a videoconference or video capture. Any suitable combination of controllable light sources, such as multiple monitors, may be used. Glare may occur in the first image due to the user’s eyeglasses or other reflective surface.

At block 204, the light source is controlled to output a changed intensity of light, such as a reduced (e.g., blanked) intensity or an increased (e.g., maximized) intensity. In the example of a display device, the backlight may be turned off or blanked momentarily. In the example of multiple display devices, one may be turned off for a given performance of block 204. A controllable lamp may be turned off or dimmed momentarily. In other examples, a display or lamp brightness may be set to its highest setting. The amount of time of changed light output may be selected to be sufficient capture one image or one video frame. For example, the light source may be controlled to have reduced output for one frame, or about 1/30th of a second when video is captured at 30 frames per second (FPS).

At block 206, a second image is captured from the scene as illuminated by the changed intensity of light. The second image will have a different character of glare from the light source. The light source is purposively modulated to allow the second image to be less or more affected by glare. The second image is captured proximate in time to the first image. For example, the second image may be captured immediately before or after the capture of the first image (e.g., about 1/30th of a second before or after the first image in 30 FPS video). In another example, the second image is captured two or three frames before or after the first image (e.g., about 1/15th to 1/10th of a second before or after the first image in 30 FPS video). Other temporal proximities are also suitable with the understanding that the nearer in time the first and second images are, the less motion or other differences between the first and second images will affect the correction for glare.

At block 208, a machine-learning model is trained with the first image and the second image. The first and second images represent, respectively, the scene under normal illumination with glare and under reduced/increased illumination and reduced/increased glare. This information is sufficient to characterize the glare and thereby to train the machine-learning model to filter out glare for subsequent images of the same scene. Examples of suitable machine-learning models are given above.

At block 210, the machine-learning model is applied to a third image captured of the scene to reduce glare in the third image. The third image may be captured after the machine-learning model is trained based on the first and second images. The third image, as filtered for glare, may be included in the video capture. The trained model may be applied to any suitable number of third images.

First, second, and third images may be captured by a user’s camera during a videoconference to correct for glare caused by a light source, such as the user’s display device also used in the videoconference and emitting light that is reflected from the user’s eyeglasses or other surface in the scene. First and second images may be captured at intervals to train the machine-learning model. Third images may be captured continuously and processed by the machine-learning model to form a video with reduced glare.

The method 200 may be repeated continually, via block 212, for the duration of a videoconference or other video capture.

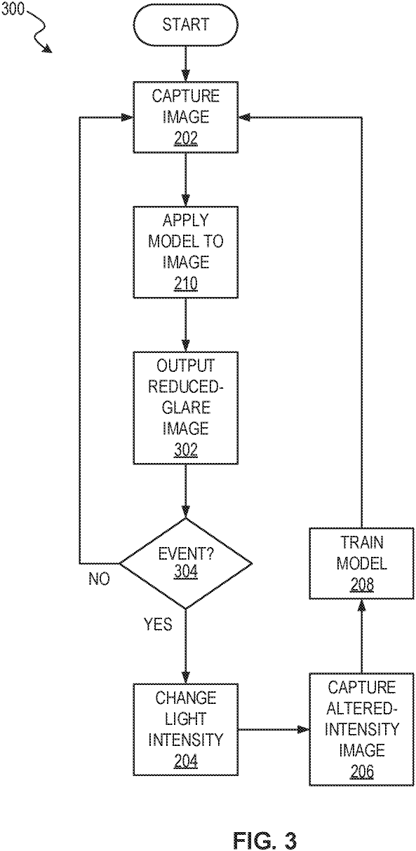

FIG. 3 shows an example method 300 to reduce glare in captured images, such as frames of video, including training a machine-learning model in response to an event, such as caused by an error function or change in content. The method 300 may be implemented with instructions that may be stored in non-transitory machine-readable media and executed by a processor. Detail concerning elements of the method 300 described elsewhere herein will not be repeated at length below; the relevant description provided elsewhere herein may be referenced for elements identified by like terminology or reference numerals.

At block 202, a true-brightness image of a scene is captured with an illuminating light source that may cause glare. The true-brightness image may contain unwanted glare.

At block 210, a trained machine-learning model is applied to the true-brightness image to obtain a reduced-glare image.

At block 302, the reduced-glare image is then outputted as a frame of the videoconference or otherwise provided as part of a captured frame in a video. Output of a video frame may include display of the frame local to the capture, communication of the frame over a computer network for remote display, saving the frame to local storage, or a combination of such.

At block 304, it is determined whether an event has occurred to trigger training of the machine-learning model. An example of a suitable event is an error in a reduced-glare image that exceeds an acceptable error. That is, an error (or loss) of a reduced-glare image may be computed and compared to an acceptable error. If the error is unacceptable, then an error event occurs. Another suitable example event is a change in content at a display device that acts as a light source that creates glare in a true-brightness image. If the content that creates the glare changes, then the character of the glare may also change. As such, a content event may be said to occur.

If an event has not occurred, blocks 202, 210, 302, 304 are repeated for the next frame. A video may thus be continually corrected for glare.

If an event occurs, then the machine-learning model undergoes training, via blocks 204, 206, 208. A glare-causing light source has its output momentarily changed (block 204) so that an altered-glare image may be captured (block 206). Then the altered-glare image and a time-proximate true-brightness image are used to train the machine-learning model (block 208). The method 300 continues with blocks 202, 210, 302, 304 to correct for glare in subsequently captured images.

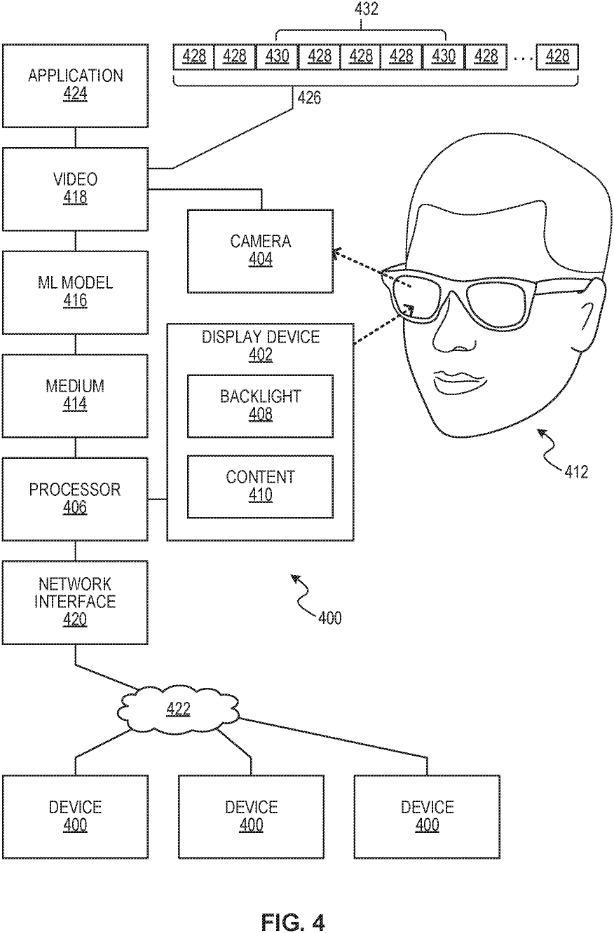

FIG. 4 shows an example device 400 to remove or reduce glare in captured images. Detail concerning elements of the device 400 described elsewhere herein will not be repeated at length below; the relevant description provided elsewhere herein may be referenced for elements identified by like terminology or reference numerals.

The device 400 may be a computing device, such as a notebook computer, desktop computer, all-in-one (AIO) computer, smartphone, tablet, or similar. The device 400 may be used to capture video, such as in a videoconference, and such video may be subject to glare caused by light emitted by a component of the device 400.

The device 400 includes a light source, such as a display device 402, a camera 404, and a processor 406 connected to the display device 402 and the camera 404. In addition to or instead of the display device 402, the light source may include a lamp or similar controllable light source.

In this example, the display device 402 includes a backlight 408. The display device 402 displays content 410 that may be related to the video capture or videoconference. The content 410 may include images of teleconference scenes remote from the device 400, shared documents, collaborative whiteboards, and similar.

The camera 404 may include a webcam or similar digital camera capable of capturing video.

The display device 402, or other light source, and camera 404 may face the user 412 of the device 400.

Examples of suitable processors 406 are discussed above. A non-transitory machine-readable medium 414 may be provided to operate in conjunction with the processor, as discussed above.

The device 400 further includes a machine-learning model 416 that provides a glare-reducing filter to video 418 that is captured by the camera 404. Examples of suitable machine-learning models 416 are given above.

The device 400 may further include a network interface 420 to provide data communications for a videoconference. The network interface 420 includes hardware, such as a network adaptor card, network interface controller, or network-capable chipset, and may further include instructions, such as a driver and/or firmware. The network interface 420 allows data to be communicated with a computer network 422, such as a local-area network (LAN), wide-area network (WAN), virtual private network (VPN), the Internet, or similar networks that may include wired and/or wireless pathways. Communication between the device 400 and other devices 400 may be made via the computer network 422 and respective network interfaces 420 of such devices 400.

The device 400 may further include video capture application 424, such as a videoconferencing application. The application 424 is executable by the processor 406.

The processor 406 controls the camera 404 to capture a sequence 426 of images or video frames, such video frames usable by the application to provide a videoconference.

During normal image capture, a light source, such as the display device 402, may illuminate the user 412 of the device 400, whether intentionally, as in the example of a lamp, or as a side effect, as in the example of a display device 402. This illumination may cause glare, such as by a user’s eyeglasses. The processor 406 applies the machine-learning model 416 to captured images 428 in the sequence 426 to reduce such glare.

The processor 406 further reduces an intensity of the light source during capture of a target, reduced-brightness image 430 that is used to train the machine-learning model 416. This may be done by momentarily turning off the backlight 408 of the display device 402. Target images 430 may be captured at intervals 432, such as in response to excessive error (loss) in the machine-learning model 416 or as triggered by a change in content 410 at a display device 402 that acts as a light source.

The processor 406 trains the machine-learning model 416 with the target image 430 and with another, normal-brightness image 428 of the sequence 426 that is temporally proximate to the target image 430. The range of brightness information provided by the target image 430 and the normal-brightness image 428 is sufficient to train the machine-learning model 416 to filter glare from other images 428 in the sequence 426.

After an instance of training, the processor 406 continues to apply the machine-learning model 416 to subsequent images 428 in the sequence 426, so as to reduce glare in the subsequent images 428.

Training may be performed at intervals 432 during the video capture and the machine-learning model 416 may thus more accurately filter glare as the subject 412 captured by the camera 404 moves and the character of light emitted by the light source changes over time.

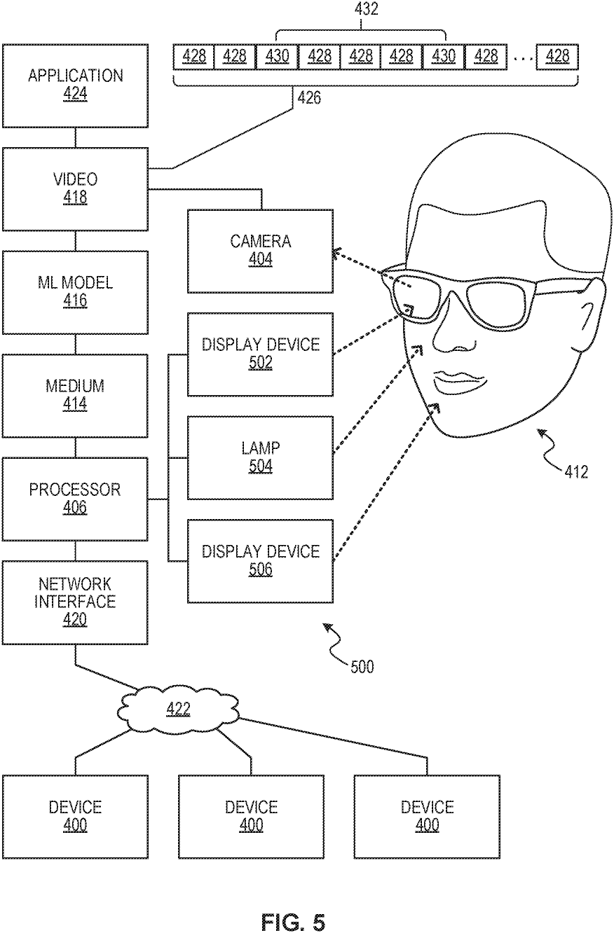

FIG. 5 shows an example device 500 to remove or reduce glare in captured images, where such glare may be caused by a plurality of light sources. Detail concerning elements of the device 500 described elsewhere herein will not be repeated at length below; the relevant description provided elsewhere herein may be referenced for elements identified by like terminology or reference numerals. The device 500 is similar to the device 400 except as discussed below.

The device 500 includes a plurality of light sources 502, 504, 506, such as multiple display devices (e.g., a desktop computer with multiple monitors), a display device and a lamp, multiple display devices and a lamp, or similar combination of light sources. The light sources 502, 504, 506 may be individually controllable. For example, each monitor of an arrangement of multiple monitors may be independently blanked to momentarily reduce light output.

Glare caused by the light sources 502, 504, 506 may be of different character. For example, a monitor directly facing the user 412 may cause glare at the user’s eyeglasses that has different shape and intensity from glare caused by a monitor that is angled with respect to the user’s viewpoint. In addition, such monitors may display different content at different times. For example, during a videoconference, the user may have one monitor displaying video of other participants and another monitor displaying a document.

To train a machine-learning model 416 that provides a glare filter, the processor 406 may selectively reduce an intensity of the plurality of light sources 502, 504, 506. That is, the processor 406 selects a light source 502, 504, 506 to reduce during capture of a target, reduced-brightness image. A given target image 430 may be captured with any one or combination of light sources 502, 504, 506 operated with reduced brightness. Independent modulation of different light sources 502, 504, 506 may provide additional brightness information to the machine-learning model 416 to increase the accuracy of the model 416 in filtering out glare. In other examples, each light source 502, 504, 506 may be associated with an independent machine-learning model 416 that filters glare caused by that light source 502, 504, 506.

In various examples, additional information may be provided to a machine-learning model to assist in characterizing and thus filtering glare. Examples of additional information include a backlight brightness and light information about displayed content, such as color and intensity. Light information may be averaged over regions of the display device, over the entire display area, or detailed pixel data may be provided.

In various examples, captured images may include visible light, infrared light, or both. Processing infrared images or an infrared component of images to filter infrared glare may be useful to assist in the removal of fire-eye by a downstream process.

In view of the above, it should be apparent that controlling a light source, such as a display device, to momentarily reduce its output may be used to train a filter for glare that may be caused by the light source. As such, distraction caused by glare in captured video may be reduced and the quality of such video may be increased. A videoconference may thus be made to appear more natural with greater verisimilitude, particularly when a user or other subject is prone to causing glare, such as by wearing eyeglasses.

It should be recognized that features and aspects of the various examples provided above can be combined into further examples that also fall within the scope of the present disclosure. In addition, the figures are not to scale and may have size and shape exaggerated for illustrative purposes.

1. A non-transitory machine-readable medium comprising instructions to:
capture a first image of a scene that includes light emitted by a display device;
change a brightness of the display device;
capture a second image of the scene while the brightness of the display device is changed;
train a machine-learning model with the first image and the second image to provide a filter to reduce glare; and
apply the machine-learning model to a third image captured of the scene to reduce glare in the third image, the third image being different from the first and second images.

2. The non-transitory machine-readable medium of claim 1, wherein the instructions are to reduce the brightness of the display device by turning off a backlight of the display device.

3. The non-transitory machine-readable medium of claim 1, wherein the instructions are to reduce the brightness of the display device, capture the second image, and train the machine-learning model at intervals during a videoconference that uses the display device.

4. The non-transitory machine-readable medium of claim 3, wherein the instructions are to control a frequency of the intervals.

5. The non-transitory machine-readable medium of claim 4, wherein the instructions are to control the frequency of the intervals based on an error function, wherein a larger error increases the frequency.

6. The non-transitory machine-readable medium of claim 3, wherein the instructions are to trigger the reduction of the brightness of the display device and the capture of the second image based on displayed content of the videoconference.

7. The non-transitory machine-readable medium of claim 1, wherein the first, second, and third images are frames of a video, and wherein the instructions are to reduce the brightness of the display device for a duration of one frame.

8. A device comprising:
a light source;
a camera; and
a processor connected to the light source and the camera, the processor to:
control the camera to capture a sequence of images;
reduce an intensity of the light source during capture of a target image of the sequence;
train a machine-learning model with the target image and another image of the sequence to provide a filter to reduce glare; and
apply the machine-learning model to subsequent images in the sequence to reduce glare in the subsequent images.

9. The device of claim 8, further comprising a network interface connected to the processor, wherein:
the light source is a display device;
the camera is a webcam; and
the processor is to provide a videoconference with the display device, the webcam, and the network interface.

10. The device of claim 9, wherein the processor is to capture the target image as triggered according to the videoconference.

11. The device of claim 8, comprising a plurality of light sources, wherein the processor is to selectively reduce an intensity of the plurality of light sources during capture of the target image.

12. The device of claim 8, wherein the machine-learning model includes a convolutional neural network.

13. A method comprising:
capturing a first image of a scene that includes light emitted by a light source;
controlling the light source to output a changed intensity of light;
capturing a second image from the scene as illuminated by the changed intensity of light;
training a machine-learning model with the first image and the second image; and
applying the machine-learning model to a third image captured of the scene to reduce glare in the third image.

14. The method of claim 13, further comprising operating a videoconference, wherein the light source is a user’s display device operated during the videoconference, and wherein the first, second, and third images are captured by the user’s camera during the videoconference.

15. The method of claim 14, wherein controlling the light source to output the changed intensity of light includes blanking the display device.
